(19) United States
(12) Patent Application Publication
(10) Pub. No.: US 2015/0030308 A1
(43) Pub. Date: Jan. 29, 2015

(54) METHOD FOR OPERATING THE PLAYBACK OF A VIDEO FILE OF AN EVENT DATA RECORDER

(71) Applicant: Transcend Information, Inc., Taipei (TW)

(72) Inventors: Kuo-Chung Yang, Hualien County (TW); Chien-Er Huang, Taipei (TW)

(73) Assignee: Transcend Information, Inc., Taipei (TW)

(21) Appl. No.: 13/950,255

(22) Filed: Jul. 24, 2013

(51) Int. Cl. G11B 27/30; H04N 9/87

(52) U.S. Cl. CPC G11B 27/30; H04N 9/87
USPC 386/230

(57) ABSTRACT

A method provides a more intuitive way of operating the playback of a video file of an event data recorder. By using GPS coordinates on a recorded video file, a route may be generated accordingly and displayed on a map. The GPS coordinates forming the route have exact mapping relation with the time line of the corresponding video file and direct operation of a slider is provided on the route of the map so that any corresponding frame of the video file may be displayed accordingly.

### BACKGROUND

1. Technical Field

The invention relates to an operation method for a video file, and more particularly, to a method for operating the playback of a video file of an event data recorder.

2. Description of the Conventional Art

An event data recorder or EDR is a device installed in some automobiles to record information related to vehicle crashes or accidents. A specific type of EDR is video event data recorder or VEDR that records video in a vehicle to create a record of accidents and for evaluating driver and vehicle performance. With the incorporation of modern GPS (global positioning system) technology, a VEDR may add GPS coordinates of the vehicle to the videos recorded by the VEDR during operation, which provides more valuable information for the drivers.

A recent VEDR comes with software to be installed on a computer. Such software provides a much convenient way for the user to examine the video clips recorded by the VEDR on a display of the computer. The GPS coordinates added to the video clips may further be placed on a map of the computer to reconstruct the route of the vehicle. However, these routes on the map are merely for viewing purpose. Each video clip can be played only by directly clicking the video clip, and the playback always starts from the very beginning of the video clip.

### SUMMARY

According to the embodiments of the invention, a method for operating a playback of a video file of an event data recorder is provided. The method includes steps: providing a first image and a second image on different areas of a screen of a display at a same time; displaying a route on the second image according to a plurality of GPS coordinates, wherein the GPS coordinates are obtained from the video file; and moving a slider along the route on the second image and the display synchronously presenting a series of corresponding frames of the video file as the first image according to the GPS coordinates the slider indicates on the route. The slider is moveable between a first end and a second end of the route and each of the GPS coordinates is obtained from a corresponding frame of the video file.

According to the embodiments of the invention, the step of providing the first image and the second image on the different areas of the screen of the display at the same time is presenting the video file recorded by the event data recorder as the first image and a map as the second image on the screen of the display.

According to the embodiments of the invention, the method further includes step: providing a list of video files on the screen of the display.

According to the embodiments of the invention, the method further includes step: displaying a plurality of routes on the second image, each route formed by a plurality of GPS coordinates obtained from a corresponding video file on the list of video files.

According to the embodiments of the invention, the method further includes step: selecting an area of the second image and displaying routes within the selected area on the second image and updating the list of video files on the screen of the display to show video files corresponding to the displayed routes within the selected area on the second image.

According to the embodiments of the invention, the method further includes step: selecting one of the routes on the second image and presenting a video file corresponding to the selected route as the first image on the screen of the display.

According to the embodiments of the invention, the method further includes step: selecting one of the video files on the list of video files and highlighting a route on the second image corresponding to the selected video file.

According to the embodiments of the invention, the method further includes step: displaying the plurality routes on the second image with different colors.

According to the embodiments of the invention, the step of providing a list of video files on the screen further includes step: categorizing the list of video files by date, week, or month.

According to the embodiments of the invention, the method further includes step: incorporating a plurality of playback functions into the first image, wherein the plurality of playback functions comprises at least one of the following actions: play, pause, stop, fast forward, and fast backward.

According to the embodiments of the invention, the first image further includes a time line with playback point, the GPS coordinates form the route and correspond to the time line, and the first end and the second end of the route respectively correspond to the start and the end of the time line.

According to the embodiments of the invention, the step of moving the slider along the route on the second image includes at least one of the following actions: play, pause, stop, fast forward, fast backward, and jump to a point, and the first image synchronously displays accordingly.

According to another embodiment of the invention, a method for operating a playback of a video file to be displayed on a screen of a display is provided. The screen has a first area and a second area, and the method includes steps: simultaneously presenting the video file on the first area and a map having a route within on the second area; detecting a control of a slider on the route of the second area; and displaying at least one corresponding frame of the video file on the first area according to the control of the slider.

According to the embodiment of the invention, the route on the map is displayed according to a plurality of GPS coordinates obtained from the video file, and each of the GPS coordinates is obtained from the corresponding frame of the video file.

According to the embodiment of the invention, the step of detecting the control of the slider on the route of the second area includes step: detecting a movement of the slider along the route on the second area, wherein the slider is moveable between a first end and a second end of the route.

According to the embodiment of the invention, the video file is obtained from an event data recorder.

According to the embodiment of the invention, the first area further includes a time line and an indicator within, and the method further includes following step: moving the indicator of the time line according to the control of the slider on the route of the second area.

According to another embodiment of the invention, a method for operating a playback of a video file to be displayed on a screen of a display is provided. The screen has a first area and a second area and the method includes steps: presenting the video file on the first area and a map having a route within on the second area; detecting a control of means for indicating a specific position of the route on the second area; and displaying at least one corresponding frame of the video file on the first area according to the indicated specific position of the route.

According to the embodiment of the invention, the route on the map is displayed according to a plurality of GPS coordinates obtained from the video file, and each of the GPS coordinates is obtained from the corresponding frame of the video file.

According to the embodiment of the invention, the means for indicating the specific position of the route on the second area is moveable between a first end and a second end of the route.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a flow chart relating to a method for operating the playback of a video file of an event data recorder according to the invention.

FIG. 2 is an illustration of an event data recorder providing video files for a computer with a display.

FIG. 3 is an illustration of an embodiment showing the screen of the display implemented with the method of the invention.

FIG. 4 is an illustration showing a mapping relation between a route and a time line according to the embodiment of the invention.

FIG. 5 is another embodiment showing a screen of the display implemented with the method of the invention.

### DETAILED DESCRIPTION

Certain terms are used throughout the following description and claims to refer to particular system components. As one skilled in the art will appreciate, manufacturers may refer to a component by different names. In the following discussion and in the claims, the terms “include” and “comprise” are used in an open-ended fashion. Also, the term “couple” is intended to mean either an indirect or direct electrical connection. Thus, if a first device is coupled to a second device, that connection may be through a direct electrical connection, or through an indirect electrical connection via other devices and connections.

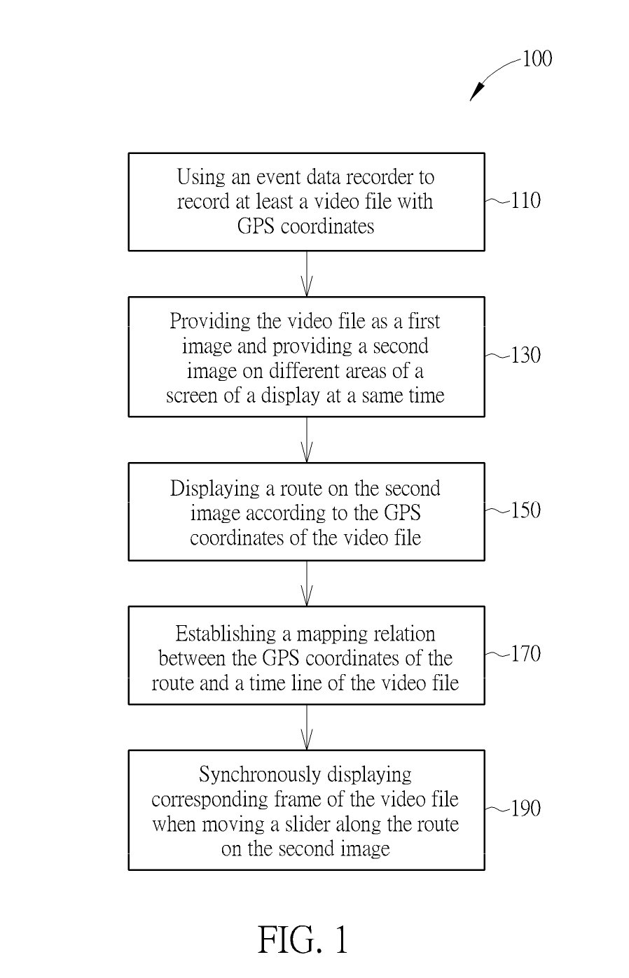

Please refer to FIG. 1. FIG. 1 is an illustration of a flow chart relating to a method 100 for operating the playback of a video file of an event data recorder according to the invention. The method 100 includes following steps:

Step 110: using an event data recorder to record at least a video file with GPS coordinates;

Step 130: providing the video file as a first image and providing a second image on different areas of a screen of a display at a same time;

Step 150: displaying a route on the second image according to the GPS coordinates of the video file;

Step 170: establishing a mapping relation between the GPS coordinates of the route and a time line of the video file;

Step 190: synchronously displaying corresponding frame of the video file when moving a slider along the route on the second image.

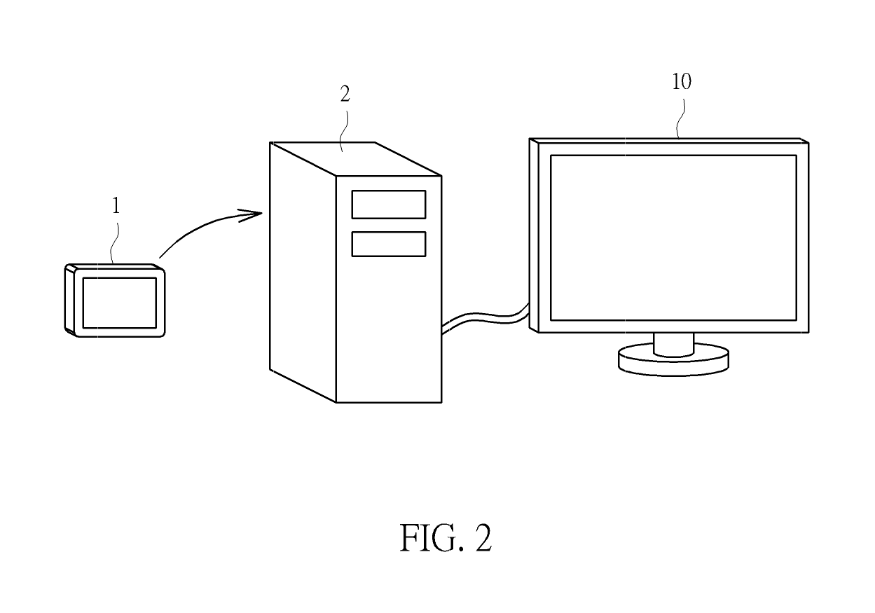

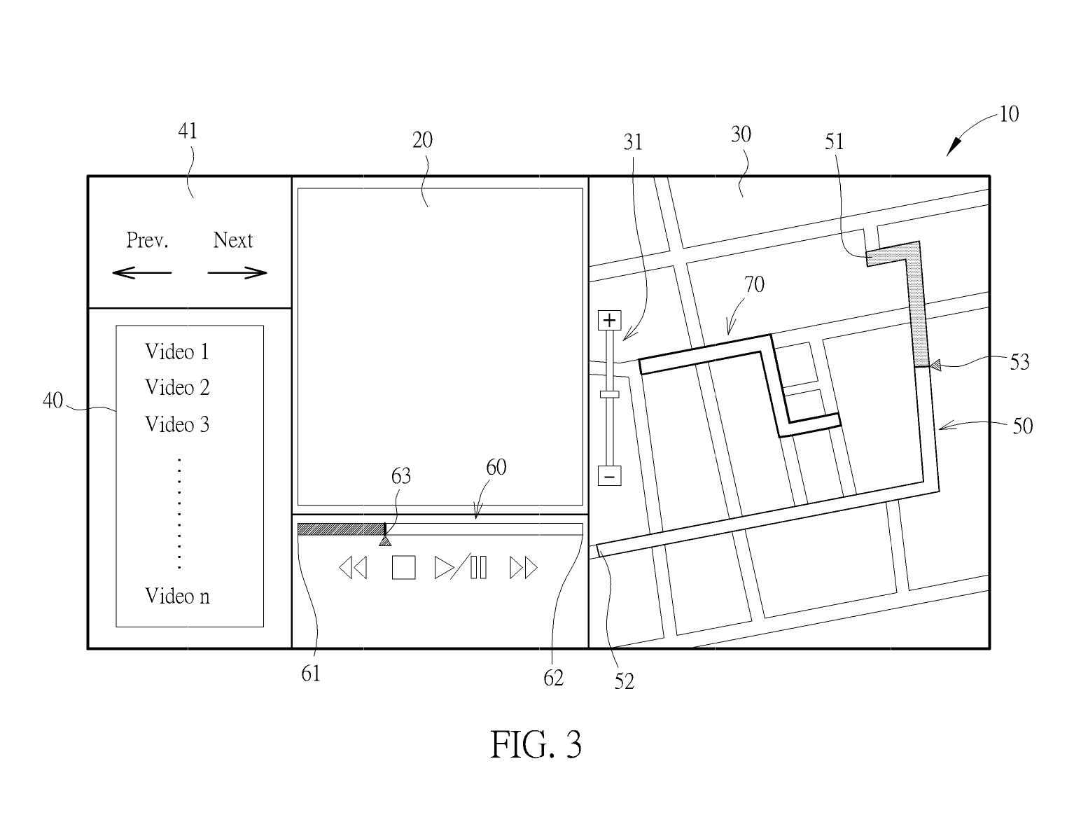

Please refer to FIG. 2 and FIG. 3 together with FIG. 1. FIG. 2 is an illustration of an event data recorder 1 providing video files for a computer 2 with a display 10 and FIG. 3 is an illustration of an embodiment showing a screen of the display 10 implemented with the method 100. In FIG. 2 and Step 110, the event data recorder or EDR 1, which is preferably a video event data recorder or VEDR, is capable of recording video files through a built-in lens and saving the video files in a computer readable medium, such as a memory card, or in an integrated storage medium. The video files recorded by the event data recorder 1 include GPS coordinates attached either to each frame of each video file or to each key frame in every few frames of each video file. Generally, a key frame is a frame that defines the starting and ending points of any smooth transition and a sequence of key frames defines which movement the viewer will see from the video file, whereas the position of the key frames in the video file defines the timing of the movement. Hence, for a video file generated by the event data recorder 1 with GPS positioning ability, each frame or each key frame of the video file is linked to a timestamp when the frame is recorded and also to a GPS coordinate where the frame is recorded. The video files are then provided for the computer 2 via the memory card or the like (not shown in FIG. 2).

In FIG. 3 and Step 130, the video file (or video files) provided for the computer 2 is provided on the screen of the display 10 as a first image 20. A different area on the screen of the display 10 is provided with a map as a second image 30, optionally with zoom scale 31 or additionally functions. In the embodiment, the video file as the first image 20 and the map as the second image 30 are presented on the screen simultaneously.

Whatever the number of video files is provided from the EDR 1 and exists in the computer 2, a list 40 of the video files may further be provided on the screen of the display 10. The list 40 of video files on the screen of the display 10 may be categorized by time period, such as date, week, or month. Users can easily click the “Previous” or the “Next” arrow in block 41 to change the category of the list 40 to another date, week, or month and any video belongs to a specific date, week, or month will be put to the list 40 and displayed. In the list 40, once a video file is selected, it will be presented as the first image 20. It should also be noted that a plurality of playback functions may be incorporated into the first image 20 as shown in FIG. 3. The plurality of playback functions may include some common functions such as play, pause, stop, fast forward, and fast backward. A time line 60 of the video file is also included in the first image 20. The time line 60 has a start 61, an end 62, and a current time indicator 63 indicating and also selecting current frame of the presented video file.

Since each video file recorded by the EDR 1 includes GPS coordinate linked to each frame or key frame of the video file, a route formed by the GPS coordinates of the video file is then displayed on the second image 30 as in Step 150. Generally, the GPS coordinates belonging to a same video file may form a route 50 on the second image 30. Some algorithms may be implemented during the formation of the route 50, according to the GPS coordinates, that take into account the evaluation and adjustment of the GPS coordinates so that the route 50 will more likely be smoother and following existing roads on the map.

As previously described, once a video file in the list 40 is clicked/selected, it will be presented as the first image 20. In one embodiment of the invention, only a route 50 formed by the GPS coordinates obtained from the video file presented as the first image 20 will be displayed on the second image 30.

In another embodiment of the invention, it may also be the case that a plurality of routes like the route 50 and a route 70, each formed by a plurality of GPS coordinates obtained from a corresponding video file on the list 40 of video files, may be displayed on the second image 30, depending on the coverage of area of the second image 30.

In still another embodiment, an area of the second image 30 may also be selected directly, either by selection using a cursor on the screen of the display 10 or by moving the zoom scale 31 to determine the selected area, and all those routes within the selected area on the second image 30 will be displayed. Once a plurality of routes is displayed on the selected area, the list 40 of video files on the screen of the display 10 may also be updated to show only video files corresponding to the displayed routes within the selected area on the second image 30. Additionally, the plurality of routes on the second image 30 may be displayed with different colors.

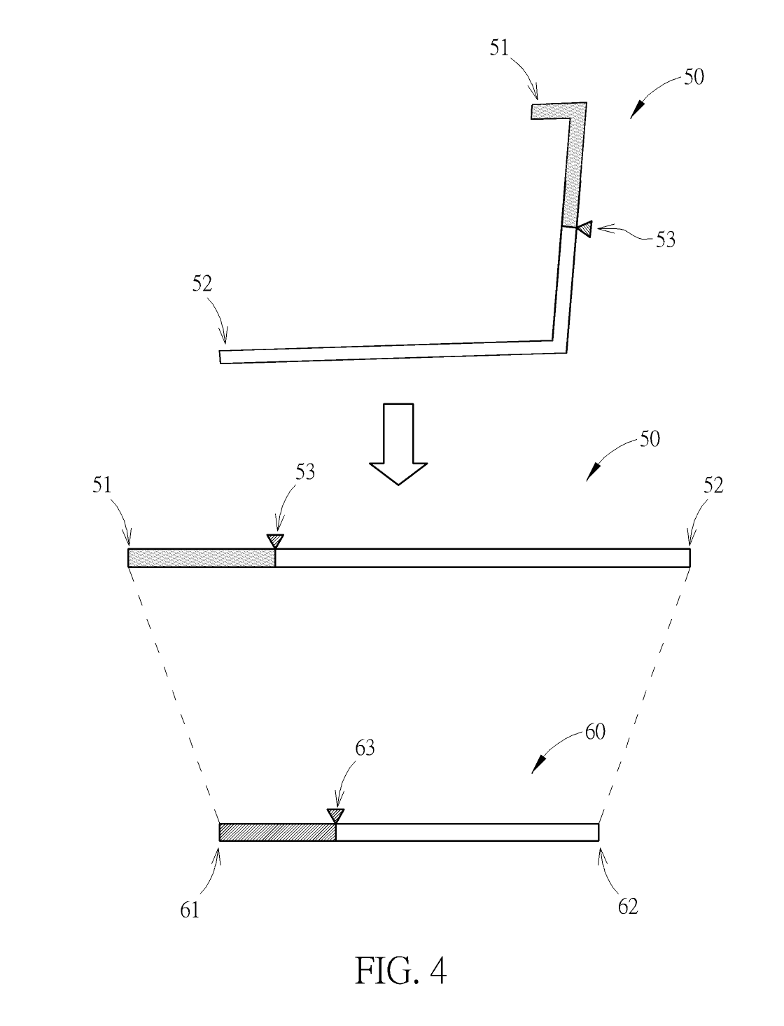

Please refer to FIG. 4 and also refer to Step 170. FIG. 4 is an illustration showing a mapping relation between the GPS coordinates of a route and a time line according to the embodiment of the invention. The method 100 of the invention provides direct operation to a route to control the playback of the corresponding video file. As shown in FIG. 3 and FIG. 4, the route 50, corresponding to a video file, has a first end 51 and a second end 52, respectively representing a start location and an end location of the route 50. Since the route 50 is “generated” from a plurality of GPS coordinates obtained from a video file, the first end 51 as the start location of the route 50 corresponds to the start 61 as the initial time of the time line 60 of the video file. Likewise, the second end 52 as the end location of the route 50 corresponds to the end 62 as the final time of the time line 60 of the video file.

It should be noted that for the mapping relation established between the GPS coordinates of the route and the time line, there might be a condition that one GPS coordinate has corresponded to more than one frame or key frame. Such condition occurs when the vehicle temporarily parks on the side of the road or waits for the traffic lights. For such condition, a color different from the rest of the route may be put to sections that contain these GPS coordinates on the route for auxiliary indicating purpose.

To provide controllability of the route 50, a slider 53 is added to the route 50 on the second image 30. The slider 53 may be moved along the route 50 between the first end 51 and the second end 52 and may be placed at any position therebetween. The movement of the slider 53 also has properties of moving direction and moving speed. Also regarding Step 170, moving the slider 53 along the route 50 on the second image 30 moves the current time indicator 63 correspondingly. Moving the slider 53 along a specific direction, toward the first end 51 or toward the second end 52 at a specific speed, also applies on the movement of the current time indicator 63 of the time line 60, fast forward or back forward. With such mapping relation established between the GPS coordinates of a route and the time line of corresponding video file as in Step 170, it is possible to have more intuitive operation of the playback of the video file.

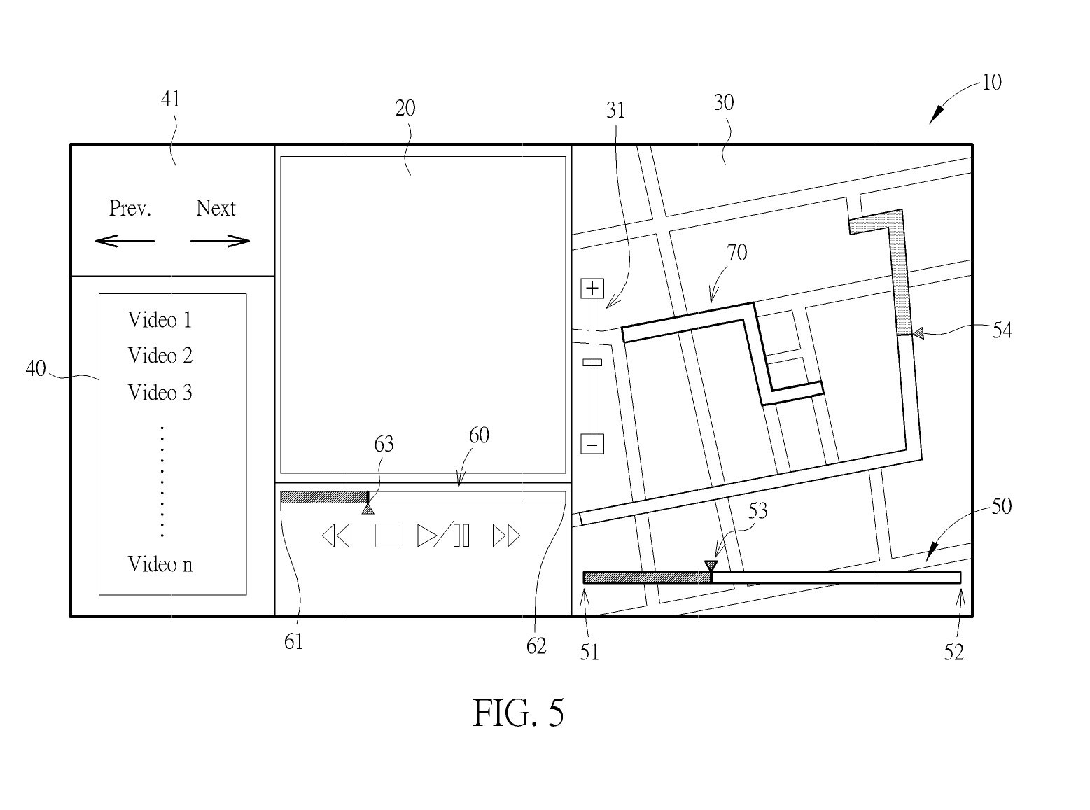

Please refer to FIG. 5, which is another embodiment showing a screen of the display 10 implemented with the method 100. For a much easier controllability, the route 50 on the second image 30 may also be “visually straightened” and be presented as a second copy on the second image 30. In this case, user will be provided with easier operation on the slider 53, and controls the slider 53 just as the same way. A position indicator 54 may be put to the original route with real-time reflection to the slider 53. In summary, the slider 53 and the position indicator 54 provides means for indicating a specific position of the route on the second image 30.

Please refer to FIG. 3 again and also refer to Step 190. Whenever the slider 53 is moved along the route 50 on the second image 30, there is a GPS coordinate at the exact location, or nearest the location of the slider 53 on the route 50, and since each GPS coordinate is obtained from a specific frame or key frame of the video file presented as the first image 20 on the screen of the display 10, the first image 20 synchronously displays the corresponding frame of the video file. In other words, moving the slider 53 along the route 50 synchronously display a series of corresponding frames of the video file. Additionally, the movement of the slider 53 along the route 50 may also be given a plurality of functions such as play, pause, stop, fast forward, fast backward, and jump to a point, etc, and the current time indicator 63 of the time line 60 and the playback of the first image 20 act accordingly.

For example, assuming a number of routes are displayed on the second image 30 according to the selection process as described, one of the routes, say route 70, may be selected by simply clicking the route 70, and a video file corresponding to the route 70 is then presented as the first image 20 on the screen of the display 10. It should be noted that a video file on the list 40 of video files may also be selected and a route corresponding to the selected video file will be highlighted on the second image 30. The video file may begin to play either once a corresponding route is selected, or when a route is selected and further clicked. The specific click position of the selected route determines where to begin to play the video file. For another example, when the slider 53 is clicked and dragged forward, or toward the second end 52, the video file is also played in a fast forward manner, and when the slider 53 is clicked and dragged backward, or toward the first end 51, the video file is also played in a fast backward way.

According to the above embodiments, the method provides a more intuitive way of operating the playback of a video file of an event data recorder. By using GPS coordinates on a recorded video file, a route may be generated accordingly and displayed on a map. The GPS coordinates forming the route have exact mapping relation with the time line of the corresponding video file and direct operation of a slider is provided on the route of the map so that any corresponding frame of the video file may be displayed accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for operating a playback of a video file of an event data recorder, comprising steps:
providing a first image and a second image on different areas of a screen of a display at a same time;
displaying a route on the second image according to a plurality of GPS coordinates, wherein the GPS coordinates are obtained from the video file; and
moving a slider along the route on the second image and the display synchronously presenting a series of corresponding frames of the video file as the first image according to the GPS coordinates the slider indicates on the route;
wherein the slider is moveable between a first end and a second end of the route and each of the GPS coordinates is obtained from a corresponding frame of the video file.

2. The method of claim 1, wherein the step of providing the first image and the second image on the different areas of the screen of the display at the same time is presenting the video file recorded by the event data recorder as the first image and a map as the second image on the screen of the display.

3. The method of claim 1, further comprising step: providing a list of video files on the screen of the display.

4. The method of claim 3, further comprising step: displaying a plurality of routes on the second image, each route formed by a plurality of GPS coordinates obtained from a corresponding video file on the list of video files.

5. The method of claim 4, further comprising steps:
selecting an area of the second image and displaying routes within the selected area on the second image; and
updating the list of video files on the screen of the display to show video files corresponding to the displayed routes within the selected area on the second image.

6. The method of claim 4, further comprising steps:
selecting one of the routes on the second image; and
presenting a video file corresponding to the selected route as the first image on the screen of the display.

7. The method of claim 4, further comprising steps:
selecting one of the video files on the list of video files; and
highlighting a route on the second image corresponding to the selected video file.

8. The method of claim 4, further comprising step: displaying the plurality routes on the second image with different colors.

9. The method of claim 3, wherein providing a list of video files on the screen further comprising step: categorizing the list of video files by date, week, or month.

10. The method of claim 1, further comprising step: incorporating a plurality of playback functions into the first image, wherein the plurality of playback functions comprises at least one of the following actions: play, pause, stop, fast forward, and fast backward.

11. The method of claim 1, wherein the first image further comprises a time line with playback point, the GPS coordinates form the route and correspond to the time line, and the first end and the second end of the route respectively correspond to the start and the end of the time line.

12. The method of claim 1, wherein moving the slider along the route on the second image comprises at least one of the following actions: play, pause, stop, fast forward, fast backward, and jump to a point, and the first image synchronously displays accordingly.

13. A method for operating a playback of a video file to be displayed on a screen of a display, the screen having a first area and a second area, the method comprising steps:
simultaneously presenting the video file on the first area and a map having a route within on the second area;
detecting a control of a slider on the route of the second area; and
displaying at least one corresponding frame of the video file on the first area according to the control of the slider.

14. The method of claim 13, wherein the route on the map is displayed according to a plurality of GPS coordinates obtained from the video file, and each of the GPS coordinates is obtained from the corresponding frame of the video file.

15. The method of claim 13, wherein the step of detecting the control of the slider on the route of the second area comprises:
detecting a movement of the slider along the route on the second area, wherein the slider is moveable between a first end and a second end of the route.

16. The method of claim 13, wherein the video file is obtained from an event data recorder.

17. The method of claim 13, wherein the first area further comprises a time line and an indicator within, and the method further comprises following step:
moving the indicator of the time line according to the control of the slider on the route of the second area.

18. A method for operating a playback of a video file to be displayed on a screen of a display, the screen having a first area and a second area, the method comprising steps:
presenting the video file on the first area and a map having a route within on the second area;
detecting a control of means for indicating a specific position of the route on the second area; and
displaying at least one corresponding frame of the video file on the first area according to the indicated specific position of the route.

19. The method of claim 18, wherein the route on the map is displayed according to a plurality of GPS coordinates obtained from the video file, and each of the GPS coordinates is obtained from the corresponding frame of the video file.

20. The method of claim 18, wherein the means for indicating the specific position of the route on the second area is moveable between a first end and a second end of the route.
